(19) United States
(12) Patent Application Publication
(10) Pub. No.: US 2006/0133247 A1
(43) Pub. Date: Jun. 22, 2006

(54) Apparatus for processing information stored in a data carrier, data carrier and method for storing a file with a plurality of related sub-files in said carrier

(75) Inventor: Johannis Friso Rendert Blacquiere, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/560,684

(22) PCT Filed: Jun. 3, 2004
(86) PCT No.: PCT/IB04/01911

§ 371 Date: Dec. 14, 2005

(30) Foreign Application Priority Data
Jun. 19, 2003 (EP) 03300033.2

(51) Int. Cl. G11B 5/09

(52) U.S. Cl. 369/53.2; 369/47.1

(57) ABSTRACT

This apparatus is designed for processing information stored in a data carrier in which information can be stored in many layers (L0, L1, . . . ) Often said information is arranged in files and related sub-files. It is proposed to arrange the file and the related sub-file in the same vicinity so that a displacement from the main file to a related sub-file is quickly made and vice versa. Application: video streams, for example, which have a certain quality level. For example, the quality is good for usage on a small portable screen. If a user wants to display this stream on a (large) screen, the enhancement sub-files placed in other layers can be used, which provides additional quality to the base layer stream.

### FIELD OF THE INVENTION

The present invention relates to an apparatus for processing information stored in a data carrier in which information can be stored in places defined by a first position indication and by at least a second position indication, comprising:
a carrier head for reading and/or writing data in said data carrier,
control means for moving said carrier head in accordance with the positions.

This apparatus finds many applications, notably for data carriers constituted by optical discs having a plurality of layers, which are scanned by a head comprising a laser. In this case, the first indication is provided by a location on the disc where the carrier head must be placed and the second position by the layer on which the laser of the carrier head must be focused.

In such discs, a file may be linked to other sub-files, and it is necessary to combine files and sub-files for a correct management of the information contained in them. This is the case, especially for the purpose of displaying movies with enhancement on a display device enables this possibility.

### BACKGROUND OF THE INVENTION

A known device of this type is disclosed in the patent document US 2002/0054550. This document discloses no measures for the processing of files and related sub-files.

### SUMMARY OF THE INVENTION

The invention proposes an above-mentioned apparatus, which enables the processing of files and related sub-files with a relative short access time.

For this purpose, such an apparatus for processing information stored in a data carrier in which information can be stored in places defined by a first position indication and by at least a second position indication comprises:
a carrier head for reading and/or writing data in said data carrier,
control means for moving said carrier head in accordance with the positions,
   wherein said information stored in the data carrier is arranged in files and related sub-files such that at least a part of a file with its related sub-file is made accessible from said first position.

The invention also proposes a data carrier comprising data organized in files and related sub-files such that at least a part of a file and its related sub-file are close together.

Moreover, the invention proposes a method of storing a file with a plurality of related sub-files comprising the steps of:
placing the file at a given location, and
placing the related sub-files close together.

### BRIEF DESCRIPTION OF THE DRAWINGS

These and other aspects of the invention are apparent from and will be elucidated, by way of non-limitative example, with reference to the embodiment(s) described hereinafter.

FIG. 1 shows an apparatus in accordance with the invention.

FIG. 2 shows an optical disc involved in the invention.

FIG. 3 shows a first embodiment of file disposal according to the invention.

FIG. 4 shows a second embodiment of file disposal according to the invention.

FIG. 5 shows the second embodiment of file disposal without a gap between certain files.

### DETAILED DESCRIPTION OF THE PREFERRED EMBODIMENTS

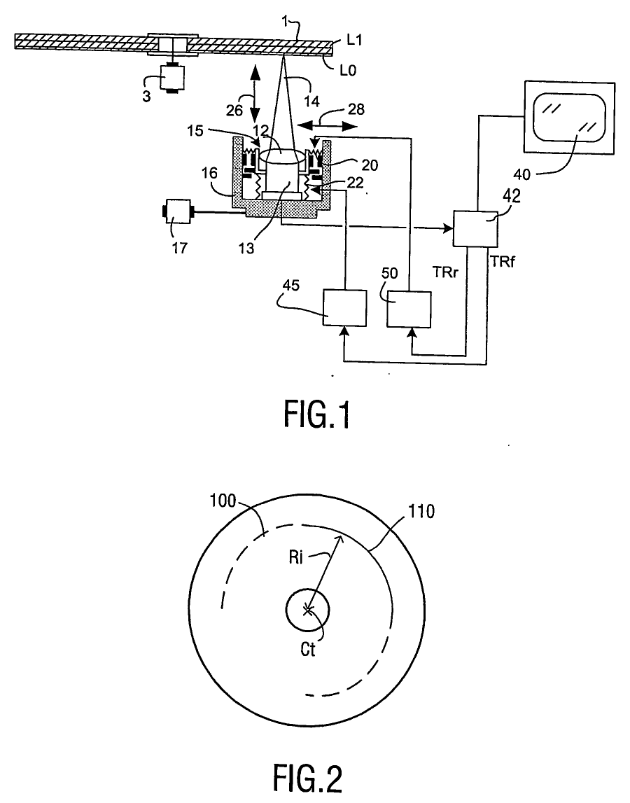

FIG. 1 shows an apparatus in which a data carrier 1 is placed. This data carrier may be an optical disc comprising two layers L0 and L1. In FIG. 1, the carrier is shown in cross-section. A disc motor 3 rotates the carrier. On this carrier, a lens 12, incorporated in an optical head 13, focuses a laser light beam 14. The focus is put on the first layer L0 or the second layer L1. This optical head 13 is mounted in an actuator 15 which is mounted in a sledge 16 which can be moved along the radius of the carrier in dependence on the control of electronic circuits, not shown in the figure, acting on a sledge motor 17. Inside this sledge, small movements are allowed thanks to actuator devices. There are actuator devices for the radial positioning referenced 20 and for focus positioning referenced 22. Arrow 26 indicates the directions of focus positioning and arrow 28 indicates the directions of radial positioning. The actuator is formed by electrotechnical elements such as coils, magnet return springs, and the like. The sledge also contains photo detectors, which provide signals. These signals are used on the one hand for the display of pictures on a screen 40, for instance, and on the other hand for controlling various servos. A splitter device 42 directs these signals to the relevant devices. Among them, a signal TRf is used for focusing via a focusing device 45 and another TRr for radial positioning via the radial guidance device 50.

In certain cases, the coding uses a base layer file and one or more enhancement layer files called related sub-files. In this technique, a base layer file is used to encode the video stream, for example, with a certain quality level, for example a good quality for usage on a small portable screen. If a user wants to display this stream on a (large) screen, the enhancement layer files can be used, which provide additional quality to the base-layer stream.

If the enhancement layer files are used, the decoder needs access to corresponding parts of both the base layer files and one or more enhancement layer files. Typically, the base layer content is stored in a separate files on each layer L0 or L1. This means that the decoder needs corresponding data from two or more separate files more or less at the same time.

If these separate files are stored on an optical medium, the access times to these separate files may become a problem as optical drives have relative large access times compared with e.g. Hard Disc Drives. The use of relatively large buffers can solve this, as can fast optical drives with respect to data-rates. The present invention, however, proposes a solution by allocating the separate files smartly on a multi-layer disc

FIG. 2 shows the optical disc to which the measures of the inventions can be applied in a preferred way. The data in a file 110 are stored along a circular track 100 on the layer L0. The center of the disc is Ct. Another track, on the other layer L1, can be provided but it is not visible on this FIG. 2. The files relating to one and the same base file are disposed along a track that is placed at the same radius Ri and on various layers, so that all the files can be accessed with very little movement and/or by a shift of the beam focus.

The relatively long access times of optical drives are a result of disc spinning in the case of CLV (constant linear velocity) media and of the optical head 13 movements. Focusing on another layer in the case of multi-layer discs, however, is a very fast process in itself (i.e. when both access points are on the same radius Ri and no optical head movement or disc spinning is required).

The measures provided by the invention involve an allocation of the various files of the multiple layers (base and enhancement) such that the total overhead time (mainly caused by jumping over the disc) is minimized. The basic idea is shown below for a dual-layer disc with a base layer and two enhancement layers.

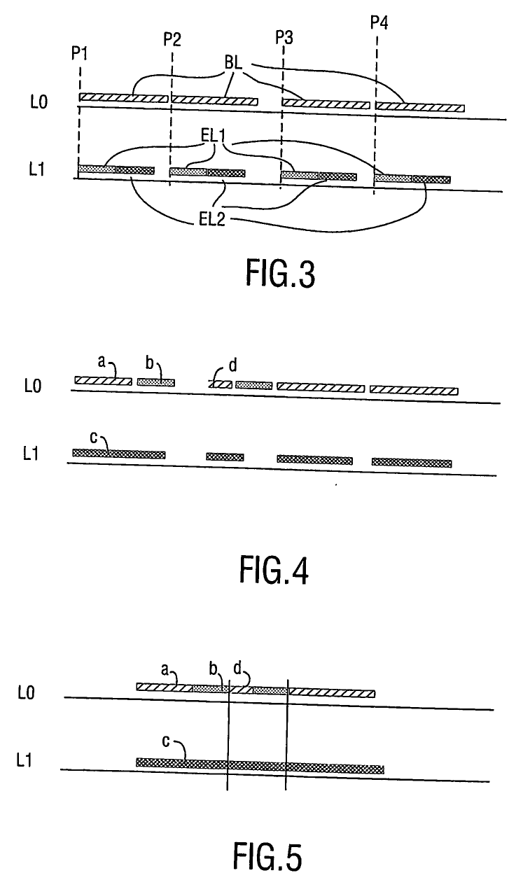

In the example, see FIG. 3, the base layer file BL is located in four regions on layer L0 of the disc. The enhancement layers or related sub-files EL1, EL2 are located on layer L1 of the disc. The corresponding parts of the three files (base layer and two enhancement layers) are located as much as possible on the same radius Ri (but on different layers) at given position P1, P2, P3 and P4. From such a given position it is easy and fast to access the files on L0 and L1 by shifting the focusing.

The sizes of and the number of regions chosen have been given only by way of example. This also means that the number of regions of the file containing the base layer and the number of regions of the files containing the enhancement layers do not have to be equal (as they are in the example). Also, the location of the base layer file on L0 and the enhancement layers sub-files on L1 as shown in FIG. 4 and FIG. 5 may be interchanged. Many other examples are obviously conceivable.

Normally the base layer files and the enhancement layers files do not strongly differ in size, thereby allowing to use the allocation structure as given in FIG. 3. However, there are no restrictions as to the sizes of the various layers, so in theory it is possible to have a large base layer and a small enhancement layer or the other way around. In the example shown in FIG. 4, a possible allocation is given for a small base layer and a relative large enhancement layer.

In this example shown in FIG. 4, a region of the base layer file (a) is read on the layer L0 of the disc, followed by the corresponding region of the enhancement layer file on sub-file (b) and the region of another sub-file (c) on the layer L1. After that, the same sequence is followed for the other regions or other sub-files (d and so on).

In both examples there is some space or gap left between the regions (on each of the disc layers). This is done mainly to make the drawings clearer. In usual cases, no space is left between the extents (however, it is of course allowed to leave this space). For clarification purposes, the example shown in FIG. 4 is redrawn below with the regions contiguously on disc, of FIG. 5.

The advantages of this manner of allocating the various corresponding files on disc can be found in the field of total performance of the drive system, as less time spent on jumping leaves more time to read data. Next to that, there are also advantages in the total power consumption (less time spent on jumping leaves time to switch parts or the entire drive off for some periods of time, thereby saving power), noise reduction by jumping less, less wear of the drive due to the jumping, etc.

An advantage relating to a totally different issue is formed in defect management. Suppose a scratch on the disc surface ruins some data. Such a scratch typically causes data to be lost on both the first and the second layer. Allocating the data as described above will lead to the loss of a (more or less related) part of the video in both the base layer and the enhancement layers. This is an advantage because, if the base layer file is lost, the information in the enhancement layer is of no value anymore. Therefore it is better to lose the corresponding information of the enhancement layer than to lose some other information at another point in the video stream.

Although in practice with small errors the data lost in the two files on both disc layers will not correspond entirely from a timing point of view, this will be the case with large error regions.

The invention also relates to the management of the defects on an optical disc from the above considerations.

1- An apparatus for processing information stored in a data carrier in which information can be stored in places defined by a first position indication and by at least a second position indication, comprising:
a carrier head for reading and/or writing data in said data carrier,
control means for moving said carrier head in accordance with the positions,
wherein said information stored in the data carrier is arranged in files and related sub-files such that at least a part of a file with its related sub-file is made accessible from said first position.

2- An apparatus as claimed in claim 1, wherein the data carrier is a removable one.

3- An apparatus as claimed in claim 1 wherein the data carrier is an optical disc comprising at least two layers, the first position indication defining a location on the surface area of the disc and the second position indication defining the envisaged layer.

4- An apparatus as claimed in claim 1, wherein means are provided for managing a defect in a file on the basis of other, related files.

5- A data carrier suitable for use in an apparatus as claimed in claim 1, comprising data organized in files and related sub-files such that at least a part of a file and its related sub-file are close together.

6- A data carrier as claimed in claim 5, constituted by an optical disc having at least two layers, wherein the files with their related sub-files are on different layers in the same locations of the disc.

7- A data carrier as claimed in claim 6, wherein the files and related sub-files are placed close together in one or a plurality of layers.

8- A method of storing a file with a plurality of related sub-files, comprising the steps of:
placing the file at a given location, and
placing the related sub-files close together.

9- An optical head suitable for an apparatus as claimed in claim 1.
